(19) United States
(12) Patent Application Publication
(10) Pub. No.: US 2008/0133282 A1
(43) Pub. Date: Jun. 5, 2008

(54) MEETING RESOURCE SCHEDULING BASED UPON ATTENDEE PARTICIPATION TYPES

(76) Inventors: Sergei R. Landar, Cambridge, MA (US); Tolga Oral, Winchester, MA (US)

Correspondence Address: HOFFMAN, WARNICK & D'ALESSANDRO LLC, 75 STATE STREET, 14TH FLOOR, ALBANY, NY, 12207, US

(21) Appl. No.: 11/566,345

(22) Filed: Dec. 4, 2006

(51) Int. Cl. G06Q 10/00

(52) U.S. Cl. 705/5; 705/8

(57) ABSTRACT

The system and method of the present invention provides automatic tools and visual hints to a meeting host who is scheduling a meeting to book meeting related resources more efficiently by utilizing pre provided profile information and additional meta data from meeting confirmations. When host schedules a meeting, he selects the location information and checks the “visual” flag if needed. Any point in time, each attendee fills in user profile information. Upon accepting invitation, each attendee fills in the type of attendance field. Each attendee, after accepting invite, can change the type of participation by going to the calendar system and changing his settings. The change will be sent to the server to update the scheduled meeting object. A reservation system that is connected to the scheduling system would then collect information about the meeting type and required resource allocated and make the necessary bookings accordingly. The auto assigned resources can include (but are not limited to):
conference room—if invitees plan to attend in-person
conference room with projector—if invitees plan to attend in-person and visual information to be present
dial in conference call number—if remote invitees attending the meeting
online meeting—if remote invitees attending the meeting, if meeting scheduled with visual information to be present.

### FIELD OF THE INVENTION

The invention relates generally to scheduling meetings, and, more particularly, to a system and method for meeting resource scheduling based upon attendee participation types.

### BACKGROUND OF THE INVENTION

In the past, excessive resources may be used (and some resources wasted) when meetings are scheduled. For instance,
1. A conference room is booked, but only 1 person shows up just to return to the office and dial in from there;
2. Conference call number used for the meeting is statically assigned per person (host) and usually has some default capacity that is way beyond the actual need of the 99% of the calls;
3. Online meetings—scheduled with default capacity, many times not even used when all participants or attendees come in person and screen projection is used instead;

Part of the problem is that hosts, when scheduling a meeting, do not have information about the type of attendance to expect (in person, remote, phone only, etc). Another part of the problem—even if the information was available, it may change over time, but adjusting booked resources is a very manual and time consuming process that only a few can afford. The invention described below addresses both problems.

There have been attempts to solve these problems. For example, U.S. Pat. No. 6,324,517, entitled “Meeting site selection based on all-inclusive meeting cost” describes meeting or conference facilities are evaluated based on an all-inclusive meeting cost. The all-inclusive meeting cost is used to rank the facilities based on the lowest all-inclusive meeting cost or on highest quality below a maximum cost. Meeting planners can then compare total meeting cost at facilities with different characteristics, and find the facilities that offer the most value. An application server is used to calculate all-inclusive meeting cost from a comprehensive database of cost factors. The list of generated meeting facilities and their costs can be generated quickly for a large number of potential meeting facilities.

Another U.S. Pat. No. 5,124,912, entitled “Meeting management device”, describes a meeting management device of a computer system which determines the optimal meeting date and time for a specified group of invitees within a set of specified time parameters. A subset of the invitees are designated as critical along with any specified pieces of equipment and desired meeting sites. Remote from personal calendars of the invitees, the device compares available dates and times of each critical invitee with each other and that of any critical pieces of equipment and meeting sites. The comparison determines common available dates and times in which to schedule the meeting. Available or unavailable dates and times of each invitee are defined in part by the invitee and in part by other scheduled meetings to which the invitee has been invited. The invitee may define available or unavailable dates and times automatically through his personal calendar or manually to mirror as much of his calendar as desired.

U.S. Pat. No. 6,324,517, describes a system which meeting or conference facilities are evaluated based on an all-inclusive meeting cost. The all-inclusive meeting cost is used to rank the facilities based on the lowest all-inclusive meeting cost or on highest quality below a maximum cost. Meeting planners can then compare total meeting cost at facilities with different characteristics, and find the facilities that offer the most value. An application server is used to calculate all-inclusive meeting cost from a comprehensive database of cost factors. The list of generated meeting facilities and their costs can be generated quickly for a large number of potential meeting facilities.

European Patent EP1306735, entitled “Control of a meeting room”, describes a control device and method for a meeting room for providing a common control interface technical devices such as audio-visual devices and systems for heating, ventilation and air conditioning (HVAC). According to the invention, not only technical subsystems but also service subsystems for catering, providing and servicing equipment, and travel related services such as taxi and hotel reservations are accessed through a single common user interface device. The user interface is configured to display user interface elements for controlling technical devices as well as user interface elements for communicating with service related computer applications.

United States Application 20020184063, entitled “Dynamic resource scheduling to optimize location of meeting participants”, describes a global positioning system (GPS) which is used to detect locations (dynamic locations) associated with meeting participants and the proximity between participants is used to create one or more location clusters. Next, the availability of suitable meeting locations (static locations) are identified and an optimum meeting location, given the participant clusters and their proximity to the available meeting locations, is determined. Additionally, the center of mass associated with each of the clusters is also used to determine optimal meeting locations. Lastly, participants are notified regarding the optimized location for the meeting.

In view of the foregoing, a need exists to overcome these problems by providing a system and method for meeting resource scheduling based upon attendee participation types.

### BRIEF SUMMARY OF THE INVENTION

Innovation described here provides automatic tools and visual hints to a user that is scheduling a meeting to book meeting related resources more efficiently by utilizing pre provided profile information and additional meta data from meeting confirmations.

An extension to the meeting scheduling systems allows collection of the following information:
1. Create meeting form:
   a) selectable (and hence automatically processible) meeting geographic location
      no location—remote participation only
      particular site (such as a particular building)
   b) visual information to be presented
      hint to the system to understand if online meeting needs to be scheduled for remote participants or attendees or if a room with projector is a requirement
2. User profile:
   a) selectable geographical location (such as a particular building or home office)
3. Accepting Meeting invitation form:
   a) type of attendance
      in person
      remotely
      remotely, phone only

### Usage Scenario:

When host schedules a meeting, he selects the location information and checks the “visual” flag if needed. Any point in time, each attendee fills in user profile information. Upon accepting invitation, each attendee fills in the type of attendance field. Each attendee, after accepting invite, can change the type of participation by going to the calendar system and changing his settings. The change will be sent to the server to update the scheduled meeting object.

A reservation system that is connected to the scheduling system would then collect information about the meeting type and required resource allocated and make the necessary bookings accordingly. The auto assigned resources can include (but are not limited to):
conference room—if invitees plan to attend in-person
conference room with projector—if invitees plan to attend in-person and visual information to be present
dial in conference call number—if remote invitees attending the meeting
online meeting—if remote invitees attending the meeting, if meeting scheduled with visual information to be present.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a flow chart of a process of the present invention illustrating a use case where the user (scheduler or meeting host) schedules a new meeting, selects a meeting location and sets “visual” flag if needed.

FIG. 1A is a block diagram of the system of the present invention.

FIG. 2 is a flow chart of a process of the present invention illustrating a use case where the user (scheduler or meeting host) updates a scheduled meeting by modifying the value of the meeting location and/or “visual” flag.

FIG. 3 is a flow chart of a process of the present invention illustrating a use case where an attendee, upon accepting the meeting invite, selects the type of meeting participation (in person or remote attendance).

FIG. 4 is a flow chart of a process of the present invention illustrating a use case where an attendee modifies his type of meeting participation (in person or remote attendance).

FIG. 5 is a flow chart of a process of the present invention illustrating the processing done by the message scheduling system where a new meeting request or meeting update has been received from the meeting host or an attendee.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, unless otherwise noted, the term “set” means one or more (i.e., at least one) and the phrase “any solution” means any now known or later developed solution. Additionally, the term “data store” means any type of memory, storage device, storage system, and/or the like, which can temporarily or permanently store electronic data, and which can be included in a storage and/or memory hierarchy (collectively referred to herein as a “memory hierarchy”) for a computer system.

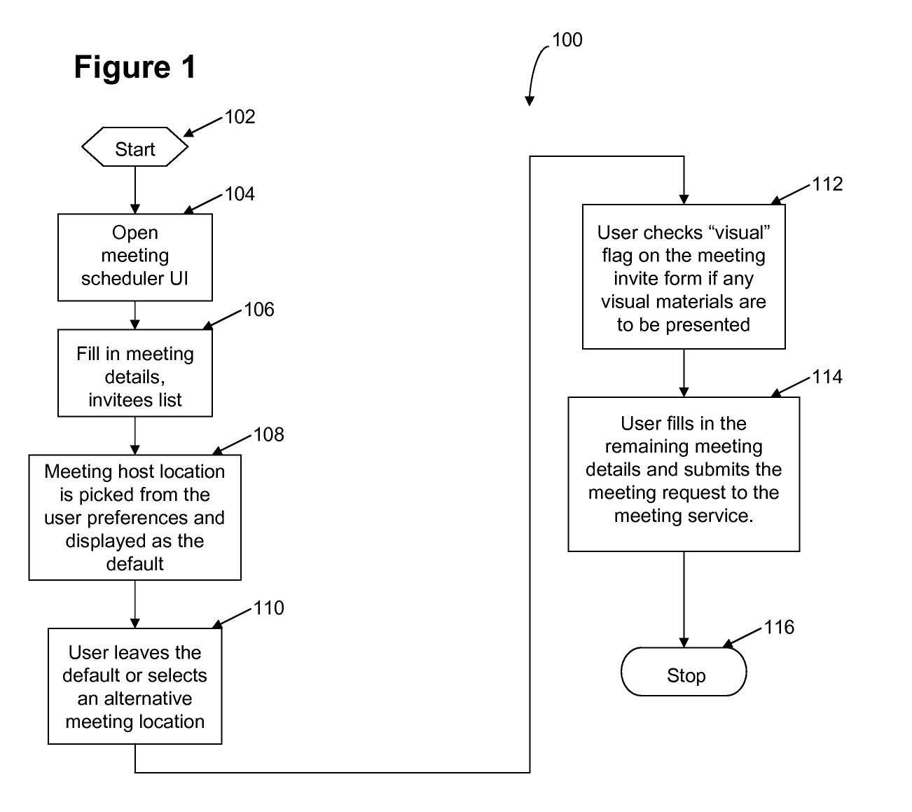

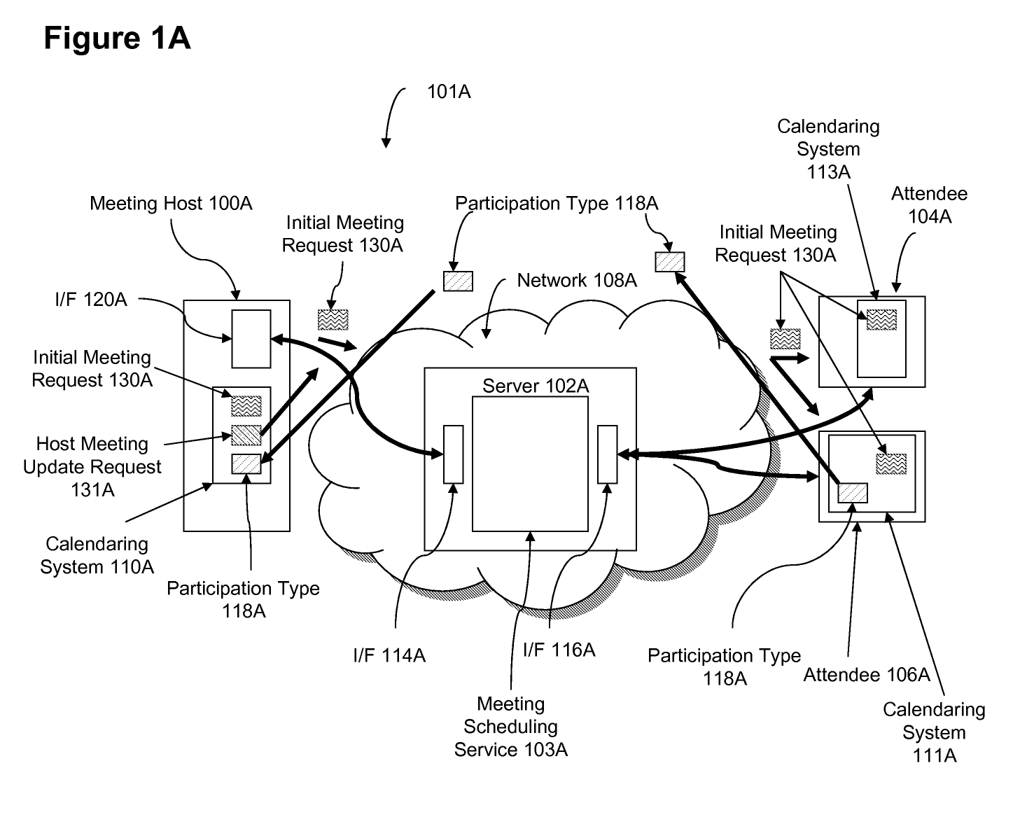

At FIG. 1, the process of the present invention is shown as 100. At “Start” 102, it moves to meeting scheduler UI 104. Then it moves to “Fill in meeting details, invitees” list at 106 where the user setting up the meeting configures the meeting details. Then it moves to the process moves to step 108 where the meeting host location is chosen user preferences. The user preferences may have many choices. For instance, the meeting location field may have a value of “No particular location—phone only” which would support mobile, remote users or home office participants. At step 110, the user leaves the default setting or selects an alternative meeting location.

At step 112, the user (meeting requester or host) checks the “visual” flag on the meeting invitation to determine whether there are any visual materials to be presented. For instance, a projector or possibly some other visual device may be necessary at the meeting. At step 114, meeting requestor fills in the remaining details and submits the meeting request to a meeting service.

This is also shown in FIG. 1A where the system of the present invention is shown as 101A. System 101A has a Meeting Host 100A, a Meeting Scheduling Service 103A and Attendees 104A, 106A. The Initial Meeting Request 130A is sent by the Meeting Host 100A to the Attendees 104A, 106A via a Meeting Scheduling Service 103A which is hosted by a Server 102A. Alternatively, Meeting Host 100A and Attendees 104A, 106A may be connected directly for communication in a “peer to peer” configuration. Server 102A is shown within a Network 108A which may be of the many various forms such as Internet, local area network (LAN), MAN, etc. Server 102 has an Interface (I/F) 114 and I/F 116 for interfacing with Meeting Host 100A, and Attendees 104A, 106A (and others).

Meeting Host 100A has an I/F 120A for interfacing with the Network 108A and Server 102A. Likewise, Attendees 104A, 106A have interface components for interfacing with the Network 108A and Server 102A. Meeting Host 100A has a Calendaring System Component 110 for allowing the Meeting Host 100A to request meetings, to keep an electronic calendar, and for receiving meeting requests from others. Likewise, Attendees Clients 104A, 106A each has a Calendaring System Component 113A, 111A for same purpose.

As shown in FIG. 1A, Meeting Host 100A creates an Initial Meeting Request 130A using his Calendaring System 110A and transmits the request to Meeting Scheduling Service 103A which forwards invites to Attendees 104A, 106A. As noted in FIG. 1, the Initial Meeting Request 130A has details such as location, “visual flag” invitees and more.

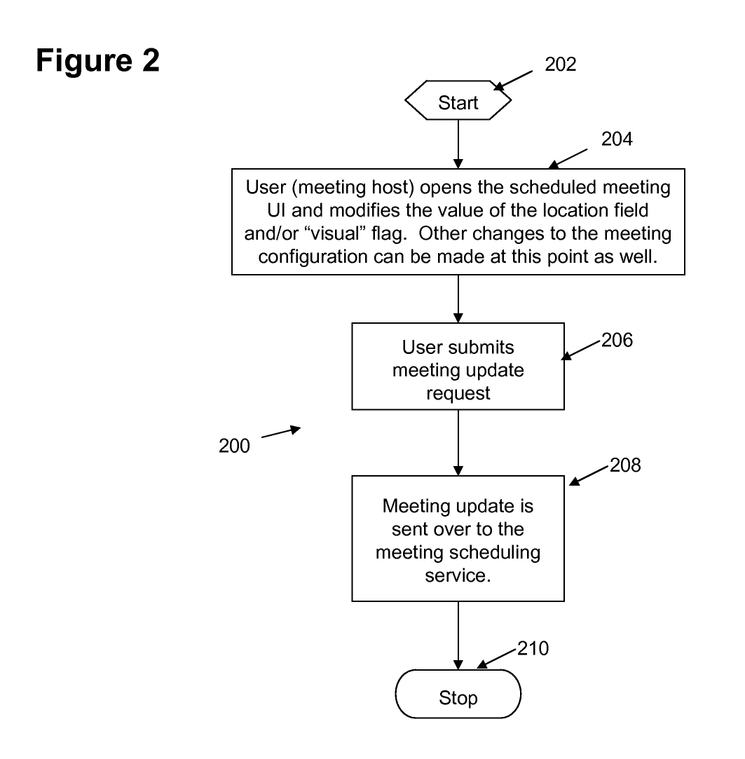

As shown in FIG. 2, a process for modifying a scheduled meeting is shown. The process 200 starts at 202 and continues to step 204 where the user (meeting host) opens the scheduled meeting user interface (UI) and modifies the location field and/or the visual flag. Of course, other changes to the scheduled meeting can be made at that time, such as time of meeting or participants.

This is shown in FIG. 1A as well where the Meeting Host 100A sends Host Meeting Update Request 131A to the Meeting Scheduling Service 103A.

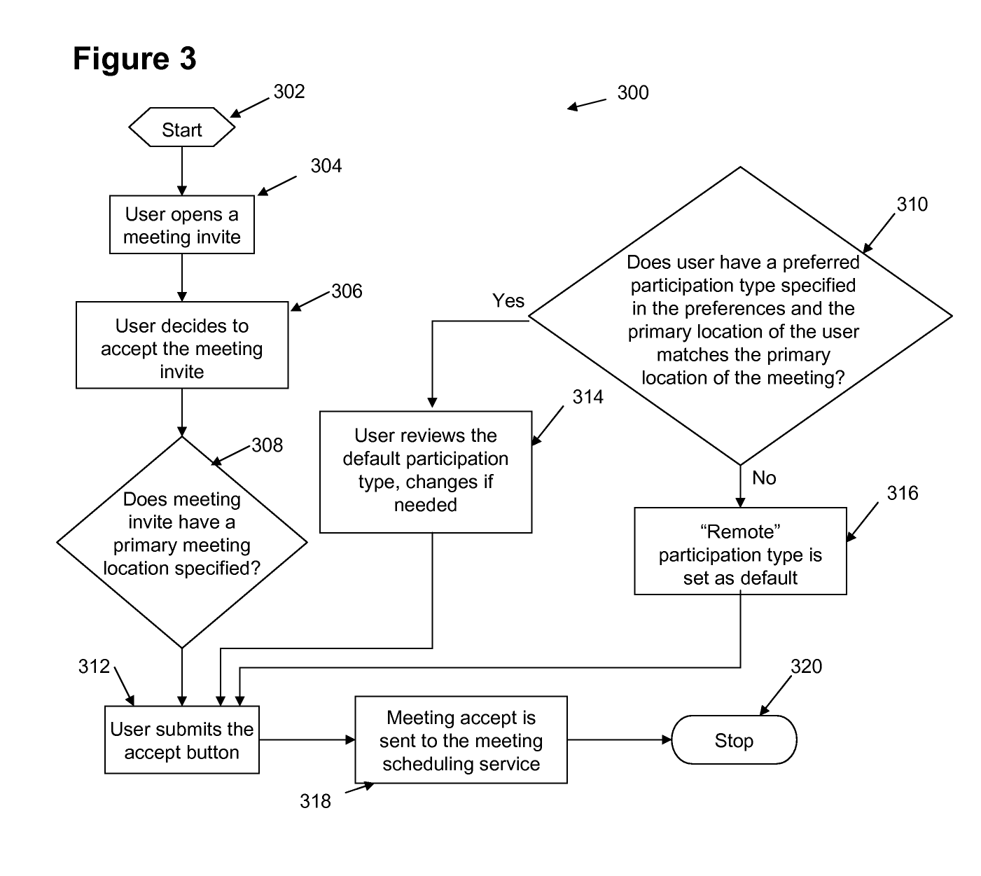

As shown in FIG. 3, a process for allowing an attendee, upon accepting the meeting invite, selects the type of meeting participation (in person or remote attendance). The process 300 starts at step 302 and continues to step 304 where the invitee opens the meeting invitation. At 306, the invitee decides to accept the meeting invitation. At 308, it is determined whether the meeting invitation has a primary location specified. If not, the invitee depresses the “Accept” action button at 312 and the “Meeting Accept” notice is sent to the meeting scheduling service at 318 and the process ends at 320. If so, the system inspects the invitee's preferences to determine whether the invitee pimary location preference. If not, “Remote” participation is set as default. If so, at 314, the invitee inspects the invitee's preferences to determine the invitee default location preference and moves to 312 as discussed above.

FIG. 1A shows this as well as Attendee 106A sends his Participation Type 118A to the Meeting Scheduling Service 103A for processing the Participation Type 118A and forwarding it along to the Meeting Host 100A.

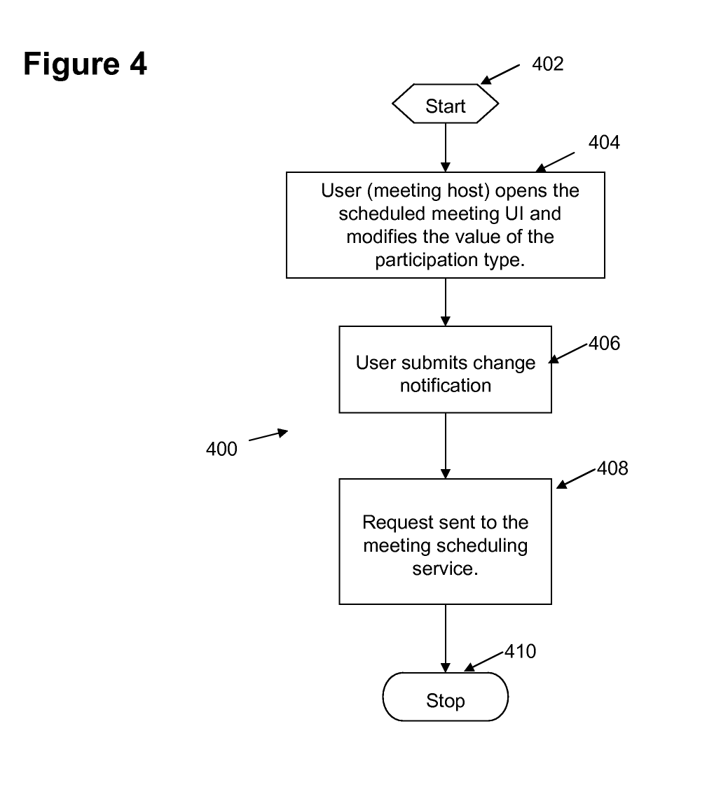

As shown in FIG. 4, a process for allowing a user (meeting attendee) to modify the value of the meeting participation type. The process 400 starts at 402 and continues to step 404 where the user (meeting attendee) opens the scheduled meeting notice using the meeting notice UI and modifies the value of the meeting participation type. At 406, the user (meeting attendee) submits a change notification which, at 408, is sent to the meeting scheduling service.

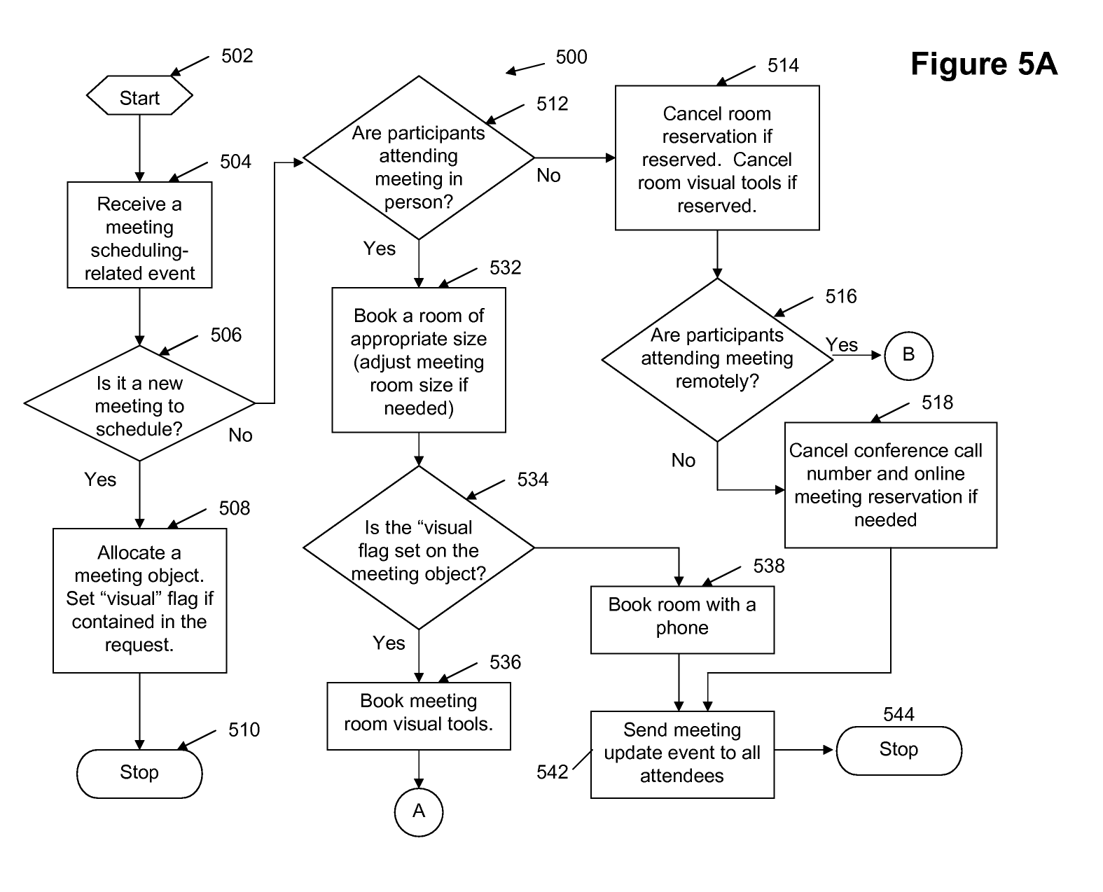

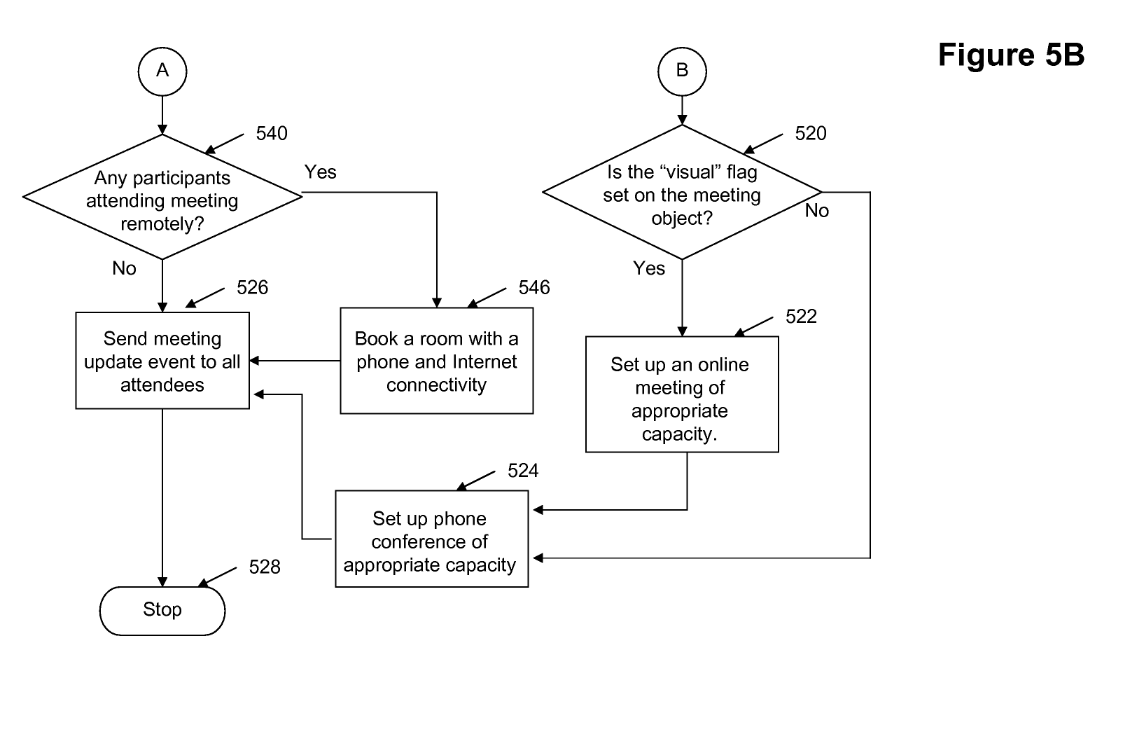

As shown in FIG. 5, a process in the meeting scheduling system for scheduling a new meeting request from a meeting host or processing a meeting update from a meeting host or from a meeting invitee is illustrated. The process 500 starts at 502 and continues to step 504 where the system receives a meeting-scheduling related event. At 506, the meeting scheduling system determines whether it is a new meeting to schedule. If so, at 508, the meeting scheduling system allocates a meeting object and sets the visual flag if contained in the request. If not, at 512, the meeting scheduling system determines whether there are any participants attending the meeting in person. If not, at 514, the meeting scheduling system cancels the room reservation if reserved and cancels the visual tools if reserved. At 516, the meeting scheduling system determines whether any participants are attending remotely. If so, the meeting scheduling system determines whether the visual flag is set at 520. If not, at 520, the meeting scheduling system sets up a phone conference of appropriate capacity and, at 526, the meeting scheduling system sends a meeting update event to all of the attendees and ends at 528.

If there are no attendees attending remotely, the meeting scheduling system, at 518, cancels the conference call-in information and online meeting reservation if initially requested. At 542, the meeting scheduling system sends a meeting update event to all of the meeting attendees and at 544 the process is complete.

If, at 512, the meeting scheduling system determines that there are participants attending the meeting in person, the process 500 moves to the next step 532 where the meeting scheduling system books a room of appropriate size based upon the number of physical attending invitees.

At 534, the meeting scheduling system determines whether there is a visual flag set on the meeting object and, if not, the meeting scheduling system books a room with a phone at 538 and sends a meeting update event to all meeting attendees at 542. If, at 534, the meeting scheduling system determines that there is a visual flag set on the meeting object, the meeting scheduling system books a room with visual tools at 536 and then moves to 540 to determine whether any participants are attending remotely. If not, sends a meeting update event to all meeting attendees at 526. If so, the meeting scheduling system books a room with a phone and Internet connectivity at 546 sends a meeting update event to all meeting attendees at 526.

What is claimed is:

1. A process, in a system having a meeting scheduling service, for scheduling a meeting by a meeting host comprising the steps of:
a. filling in, by the meeting host, meeting details into a meeting scheduler user interface (UI);
b. retrieving from the meeting host's user preferences the default host location for the meeting;
c. allowing the meeting host to choose the default location or to select an alternative location for the meeting;
d. allowing the meeting host to select a visual flag if any visual materials are to be presented; and
e. receiving, from the meeting host, at the meeting scheduler, the meeting request.

2. The process of claim 1 further wherein step c further allows the meeting host to choose “no particular location—phone only” to support remote, mobile or work at home attendees.

3. The process of claim 2 further wherein, in step d, the visual flag may indicate a projection system for in-person meetings and may indicate an online meeting reservation for phone-only meetings.

4. A process, in a system having a meeting scheduling service, for scheduling a meeting by a meeting host with attendees, the meeting host having sent a meeting invite to the attendees, the meeting invite having fields for primary meeting location and for attendee participation type, the attendee having a file consisting of his preferences and an attendee primary location, comprising the steps of:
a. the attendee opening the meeting invite;
b. in the meeting scheduling service, examining the attendee's preferences and determining whether the attendee has a preferred participation type;
c. next, in the meeting scheduling service, determining whether the primary meeting location matches the user primary location;
d. if not, remote participation is set as default and the attendee submits the accept action and the meeting accept is sent to the meeting scheduling service; and
e. if so, the attendee reviews the default participation type and changes if needed and the attendee submits the accept action and the meeting accept is sent to the meeting scheduling service.

5. The process of claim 4 wherein, after step a, further has the step of the attendee deciding to accept the meeting invite, the step of the attendee determining whether a primary location is specified, the step of, if not, the attendee submits the accept action and the meeting accept is sent to the meeting scheduling service, and, if not, moving to step b.

6. The process of claim 4 further comprising, after the attendee submitting the accept action, the steps of the attendee opening the scheduled meeting notice, modifying the meeting participation type, the attendee submitting a change notification and sending the change notification to the meeting scheduling service.

7. A process, in a system having a meeting scheduling service, for scheduling a meeting by a meeting host with attendees, the meeting host having sent a meeting request to the meeting scheduling service, the meeting request having fields for primary meeting location, for attendee participation type, and a visual flag, the attendee having a file consisting of his preferences and an attendee primary location, comprising, at meeting scheduling service, the steps of:
a. receiving request for a meeting scheduling related event;
b. determining whether it is a new meeting to schedule;
c. if it is a new meeting to schedule, allocating a meeting object and set visual flag, if contained in the request;
d. if it is not a new meeting to schedule, determining if any attendees are attending in person or remotely;
e. if attendees are attending in person, booking a room of the appropriate size to accommodate the attendees attending in person and with a phone and internet connectivity and sending a meeting update event to all attendees and, if no attendees are attending in person, canceling room; and
f. if any of the attendees are attending remotely, setting up a phone conference of appropriate capacity, setting up an online meeting of appropriate capacity and sending a meeting update event to all attendees.

8. The process of claim 7 further having, after step b, if there is a new meeting to schedule, the step of allocating a meeting object and setting the visual flag if contained in the meeting request and, after step c, if there are remote attendees, determining whether the visual flag is set on the meeting object.

9. The process of claim 8 further comprising, if the visual flag is set, the step of booking a meeting room with visual tools.

10. The process of claim 8 further comprising, if the visual flag is not set, the step of booking a meeting room with a telephone and sending a meeting update event to all attendees.

11. The process of claim 8 further comprising, if the visual flag is set and there are attendees are attending the meeting remotely, booking a meeting room with phone and internet connectivity and sending a meeting update event to all attendees.

12. A system for providing meeting resource scheduling based upon attendee participation types, the system having a meeting host, a server and at least one attendees, the meeting host having a calendaring system for initially scheduling the meeting by sending an initial meeting request to the at least one attendee via the server, the server having a meeting scheduling server for processing the initial meeting request and forwarding it to the at least one attendee, and the at least one attendee having a calendaring system for receiving the initial meeting request and for sending a participation type to the meeting host.

13. The system of claim 12 wherein the meeting host calendaring system further is for sending a host meeting update.

14. The system of claim 12 wherein the meeting host calendaring system is further for setting a visual flag in the meeting request.

15. The system of claim 12 wherein the server meeting scheduling service is for booking a room of the appropriate size based upon the number of attendees attending meeting in person.

16. A computer program comprising program code stored on a computer-readable medium, which when executed, enables a computer system to implement the following steps, in a system having a meeting scheduling service, for scheduling a meeting by a meeting host with attendees, the meeting host having sent a meeting request to the meeting scheduling service, the meeting request having fields for primary meeting location, for attendee participation type, and a visual flag, the attendee having a file consisting of his preferences and an attendee primary location, comprising, at meeting scheduling service, the steps of:
a. receiving request for a meeting scheduling related event;
b. determining whether it is a new meeting to schedule;
c. if it is a new meeting to schedule, allocating a meeting object and set visual flag, if contained in the request;
d. if it is not a new meeting to schedule, determining if any attendees are attending in person or remotely;
e. if attendees are attending in person, booking a room of the appropriate size to accommodate the attendees attending in person and with a phone and internet connectivity and sending a meeting update event to all attendees and, if no attendees are attending in person, canceling room; and
f. if any of the attendees are attending remotely, setting up a phone conference of appropriate capacity, setting up an online meeting of appropriate capacity and sending a meeting update event to all attendees.

17. The process of claim 16 further having, after step b, if there is a new meeting to schedule, the step of allocating a meeting object and setting the visual flag if contained in the meeting request and, after step c, if there are remote attendees, determining whether the visual flag is set on the meeting object.

18. The computer program of claim 17 further comprising, if the visual flag is set, the step of booking a meeting room with visual tools.

19. The computer program of claim 17 further comprising, if the visual flag is not set, the step of booking a meeting room with a telephone and sending a meeting update event to all attendees.

20. The computer program of claim 17 further comprising, if the visual flag is set and there are attendees are attending the meeting remotely, booking a meeting room with phone and internet connectivity and sending a meeting update event to all attendees.
